(19) United States
(12) Patent Application Publication
(10) Pub. No.: US 2018/0132648 A1
(43) Pub. Date: May 17, 2018

(54) COOKING VESSEL FOR AN OVEN CAVITY OF A COOKING OVEN

(71) Applicant: ELECTROLUX APPLIANCES AKTIEBOLAG, Stockholm (SE)

(72) Inventors: Riccardo FURLANETTO, Forli (IT); Paolo FARALDI, Forli (IT); Marco CARNEVALI, Forli (IT)

(21) Appl. No.: 15/577,577

(22) PCT Filed: May 25, 2016
(86) PCT No.: PCT/EP2016/061805

§ 371 Date: Nov. 28, 2017

(30) Foreign Application Priority Data
Jun. 24, 2015 (EP) 15173492.8

(51) Int. Cl. A47J 27/04; F24C 15/32; A47J 27/08; A47J 36/04; A47J 36/32; A23L 5/10

(52) U.S. Cl. CPC A47J 27/04; F24C 15/327; A47J 27/0804; A47J 27/0802; A23V 2002/00; A47J 36/32; A23L 5/13; A47J 2027/043; A47J 36/04

(57) ABSTRACT

The present invention relates to a cooking vessel (30) arrangeable or arranged inside an oven cavity (12) of a cooking oven (10). The cooking vessel (30) is provided for receiving food stuff (40) being prepared by a steam cooking process. The cooking vessel (30) is confined or confinable, so that a higher humidity inside said cooking vessel (30) as outside said cooking vessel (30) is allowed. The cooking vessel (30) is confined or confinable in such a way, that an overpressure inside said cooking vessel (30) is limited. The cooking vessel (30) comprises at least one vessel sensor (32) arranged inside said cooking vessel (30) and connectable or connected to a control unit (26) of the cooking oven (10). The vessel sensor (32) includes at least one humidity sensor and/or temperature sensor. Further, the present invention relates to a cooking oven (10) comprising at least one cooking vessel (30) arrangeable or arranged inside an oven cavity (12) of said cooking oven (10). Moreover, the present invention relates to a method for performing a steam cooking process.

The present invention relates to a cooking vessel arrangeable or arranged inside an oven cavity of a cooking oven. Further, the present invention relates to a cooking oven comprising at least one cooking vessel arrangeable or arranged inside an oven cavity of said cooking oven. Moreover, the present invention relates to a method for performing a steam cooking process.

Cooking ovens usually comprise a temperature control system in order to adjust and keep a set cooking temperature. Mostly, a temperature sensor is arranged inside the oven cavity. Said temperature sensor detects the temperature in the oven cavity itself. Furthermore, some cooking ovens comprise an additional temperature sensor insertable into the food stuff, e.g. meat, being cooked. The detected temperature values of said additional temperature sensor may be used for controlling the heating elements. Further, the both temperature sensors may be used for providing a temperature profile in the oven cavity and inside the food stuff.

Steam cooking ovens are special types of cooking ovens, wherein steam a generated and delivered in order to support the cooking process. Steam is generated by a steam generator of the cooking oven and delivered into the oven cavity via a nozzle. There are two kinds of known steam cooking ovens. A first kind is a pure steam cooking oven, wherein food stuff is prepared only by steam from the ted by the steam generator. Said pure steam cooking oven does not comprise any further heating elements besides said steam generator. A second kind is a combined steam cooking oven, wherein steam is used either exclusively for the cooking process or in combination with other heating elements.

The combined steam cooking oven is often provided with a dedicated cooking vessel connected to the steam generator. The steam is concentrated in said cooking vessel. The oven cavity may be heated by further heating elements. The remaining oven cavity outside the cooking vessel may be available for other cooking functions.

However, there is no information about the thermal conditions inside the cooking vessel during the cooking process. Thereby it is difficult for the user to estimate the cooking time of the cooking process.

It is an object of the present invention to provide a cooking vessel, which allows a determination of the thermal conditions inside the cooking vessel during the cooking process.

The object of the present invention is achieved by the cooking vessel according to claim 1.

The cooking vessel according to the present invention is arrangeable or arranged inside an oven cavity of a cooking oven, wherein
the cooking vessel is provided for receiving food stuff being prepared by a steam cooking process,
the cooking vessel is confined or confinable, so that a higher humidity inside said cooking vessel as outside said cooking vessel is allowed,
the cooking vessel is confined or confinable in such a way, that an overpressure inside said cooking vessel is limited,
the cooking vessel comprises at least one vessel sensor arranged inside said cooking vessel and connectable or connected to a control unit of the cooking oven, and
the vessel sensor includes at least one humidity sensor and/or temperature sensor.

The core of the present invention is the vessel sensor arranged inside the cooking vessel and connectable or connected to the control unit of the cooking oven. The cooking process may be controlled in dependence of the humidity and/or the temperature inside the cooking vessel. The thermal conditions inside the cooking vessel provide accurate information about the state of the food stuff. The cooking vessel is confined or confinable in such a way, that the humidity inside said cooking vessel is higher as outside said cooking vessel on the one hand and an overpressure inside said cooking vessel is limited on the other hand.

In particular, the cooking vessel includes a lower part and an upper part forming the confined or confinable cooking vessel. The cooking vessel is realized by low complexity.

For example, at least one sealing is arranged between the lower part and the upper part of the cooking vessel, wherein said sealing allows the higher humidity inside said cooking vessel as outside said cooking vessel.

Preferably, the at least one sealing is made of one or more food grade silicone materials.

According to one embodiment of the present invention, the cooking vessel includes a steam inlet connectable or connected to a steam generator of the cooking oven. In this case, the cooking vessel is provided for a steam cooking oven or a combined steam cooking oven.

Further, the steam may be generated by water, liquids and/or moisture contained in the food stuff, when the oven cavity is heated. Thus, the cooking vessel may be used in a cooking oven without any steam cooking function.

According to a further embodiment of the present invention, the cooking vessel includes a water basin arranged at the bottom of said cooking vessel, wherein food stuff is arranged or arrangeable above said water basin. Also in this case, the cooking vessel may be used in a cooking oven, which requires not necessarily the steam cooking function.

Preferably, the cooking oven comprises at least one cooking vessel mentioned above.

In particular, the cooking oven comprises at least one control unit for controlling at least one heating element of said cooking oven, wherein the vessel sensor is connected or connectable to said control unit.

Further, the control unit is connected or connectable to at least one cavity sensor of the cooking oven. Besides the thermal conditions inside the cooking vessel, additionally the temperature out of said cooking vessel may be detected.

Moreover, the cooking oven may comprise at least one steam generator and at least one steam outlet, wherein said steam outlet is arranged inside the oven cavity. The cooking vessel may be directly connected to the steam outlet of the steam generator.

Further, the present invention relates to a method for performing a steam cooking process in an oven cavity of a cooking oven, wherein
food stuff being prepared by the steam cooking process is arranged inside a confined cooking vessel,
the cooking vessel allows a higher humidity inside said cooking vessel as outside said cooking vessel,
an overpressure inside said cooking vessel is limited,
the cooking vessel is arranged inside the oven cavity,
the humidity and/or the temperature inside the cooking vessel are detected by at least one vessel sensor arranged inside said cooking vessel, and
the detected humidity and/or temperature inside the cooking vessel are used for controlling the steam cooking process.

The cooking process is controlled in dependence of the humidity and/or the temperature inside the cooking vessel. The thermal conditions inside the cooking vessel provide accurate information about the state of the food stuff.

According to one embodiment of the present invention, the steam is generated by at least one steam generator of the cooking oven, wherein the cooking vessel is connected to the at least one steam generator. In this case, the cooking vessel is provided for a steam cooking oven or a combined steam cooking oven.

According to another embodiment of the present invention, the steam is generated by water contained in a water basin arranged at the bottom of said cooking vessel, when the oven cavity is heated. In this case, the cooking vessel may be used in a cooking oven, which requires not necessarily the steam cooking function.

According to a further embodiment of the present invention, the steam is generated by water, liquids and/or moisture contained in the food stuff, when the oven cavity is heated. Also in this case, the cooking vessel may be used in a cooking oven without any steam cooking function.

The three embodiments mentioned above may be combined. Thus, the steam may be generated simultaneously by the steam generator, by the water in the water basin and/or by the water, liquids and/or moisture contained in the food stuff.

At last, the method is performed by the cooking vessel and/or by the cooking oven mentioned above.

Novel and inventive features of the present invention are set forth in the appended claims.

The present invention will be described in further detail with reference to the drawing, in which

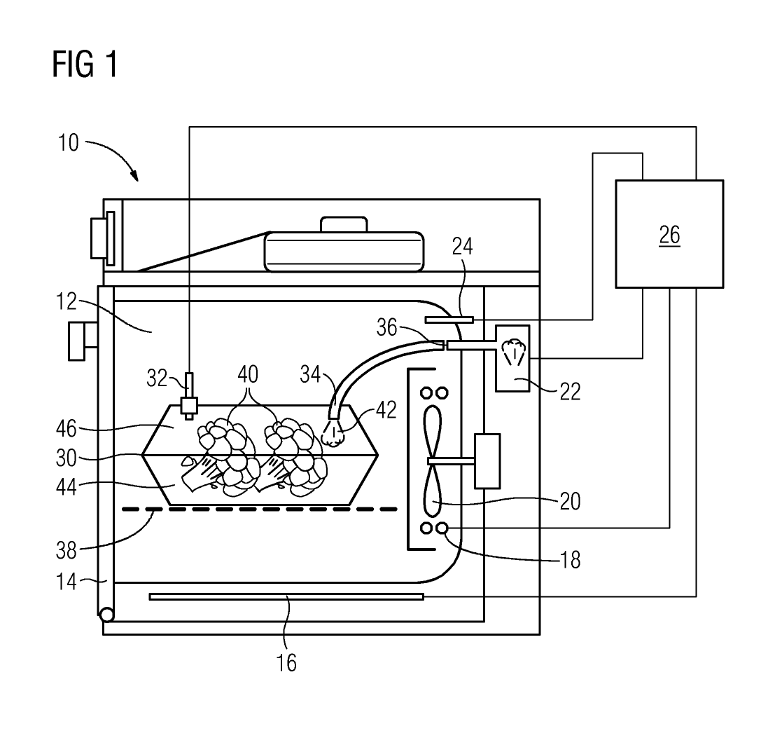

FIG. 1 illustrates a schematic sectional side view of a cooking oven with a cooking vessel according to a first embodiment of the present invention,

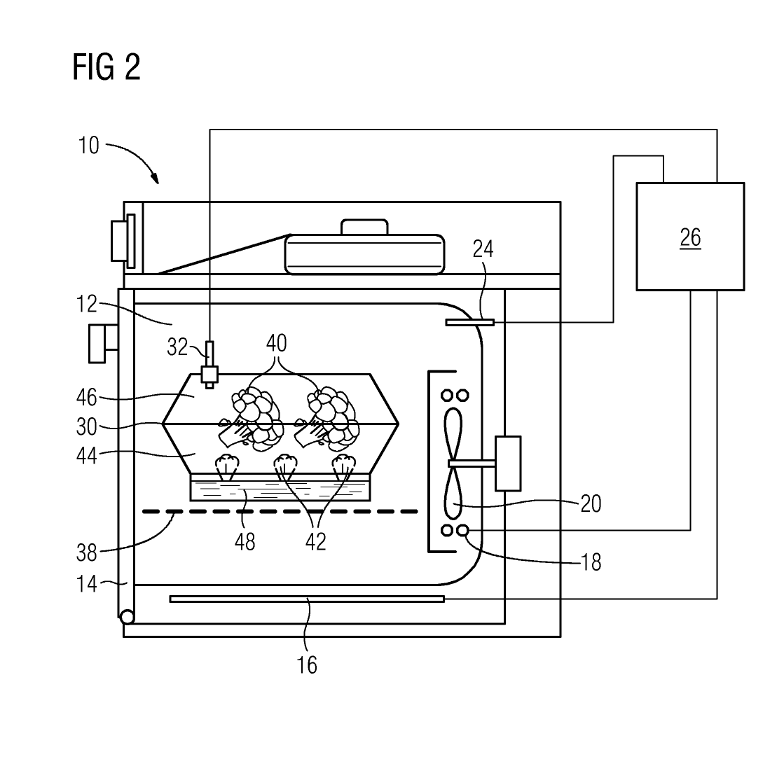

FIG. 2 illustrates a schematic sectional side view of the cooking oven with a cooking vessel according to a second embodiment of the present invention, and

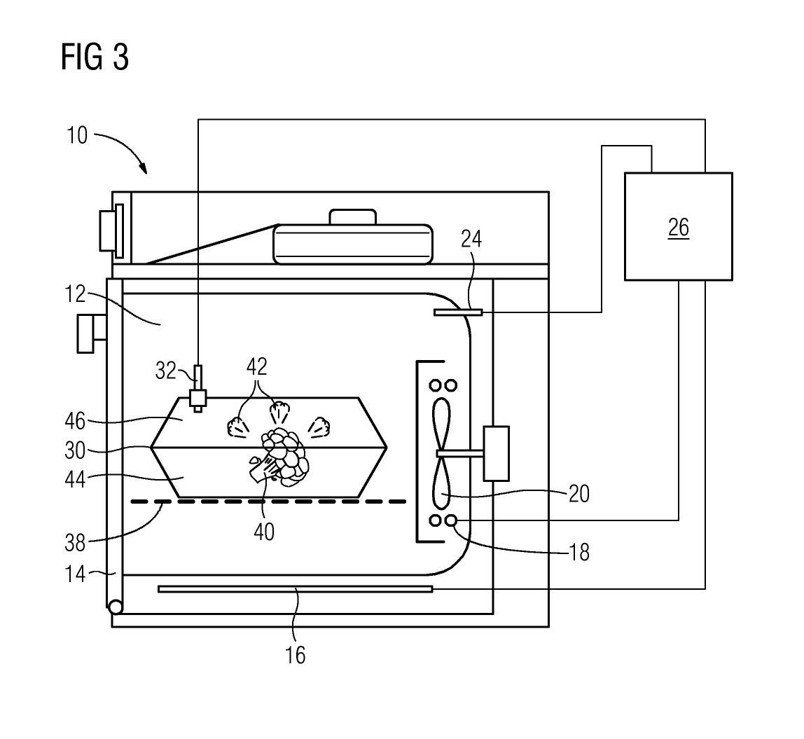

FIG. 3 illustrates a schematic sectional side view of the cooking oven with a cooking vessel according to a third embodiment of the present invention.

FIG. 1 illustrates a schematic sectional side view of a cooking oven 10 with a cooking vessel 30 according to a first embodiment of the present invention. The cooking oven 10 includes an oven cavity 12. An oven door 14 is arranged at the front side of the cooking oven 10 and provided for closing the oven cavity 12. In this example, the cooking oven 10 comprises a bottom heating element 16, a rear heating element 18 and a fan 20. The bottom heating element 16 and the rear heating element 18 are electric heating elements. The bottom heating element 16 is arranged below a bottom plate of the oven cavity 12. The rear heating element 18 is arranged in front of a rear wall of the oven cavity 12. The fan 20 encloses the rear heating element 18.

The cooking oven 10 comprises a cavity sensor 24 arranged inside the oven cavity 12. In this example, the cavity sensor 24 is arranged in the rear and upper portion of the oven cavity 12. In particular, the cavity sensor 24 is a temperature sensor. Alternatively or additionally, the cavity sensor 24 is provided as a humidity sensor. Further, the cooking oven 10 includes a control unit 26 electrically connected to the cavity sensor 24, the fan 20 and the heating elements 16 and 18. The control unit 26 may be either an integrated part of the cooking oven 10 or an external device arranged out of the cooking oven 10.

According to the first embodiment, the cooking oven 10 comprises a steam generator 22. In this example, the steam generator 22 is arranged inside the rear wall of the cooking oven 10. The steam generator 22 includes a steam outlet 36 arranged at the rear wall of the oven cavity 12. The steam generator 22 is connected to the control unit 26. The cooking oven 10 of the first embodiment is a combined steam oven, wherein steam may be used alone or in combination with other heating elements for the cooking process.

The cooking vessel 30 is arranged inside the oven cavity 12 of the cooking oven 10. In this example, the cooking oven 10 comprises a grid 38 or tray 38 insertable or inserted inside the oven cavity 12. The cooking vessel 30 is placed upon said grid 38 or tray 38 inside the oven cavity 12. Food stuff 40 is arranged inside the cooking vessel 30. In this example, the cooking vessel 30 includes a lower part 44 and an upper part 46. The cooking vessel 30 is confined. However, the cooking vessel 30 is not hermetically sealed, since an overpressure is not required inside said cooking vessel 30. The cooking vessel 30 is designed that different temperature and humidity may occur inside said cooking vessel 30 on the one hand and in the residual oven cavity 12 on the other hand.

The cooking vessel 30 includes a vessel sensor 32. The vessel sensor 32 is provided as a temperature sensor and/or as a humidity sensor. In this example, the vessel sensor 32 is arranged in the upper part 46 of the cooking vessel 30. The vessel sensor 32 is connected or connectable to the control unit 26 of the cooking oven 10. The vessel sensor 32 arranged inside the cooking vessel 30 allows a homogeneous temperature control regardless of the characteristics of the cooking vessel 30 and of the food stuff 40 to be treated. Thereby, a closed loop control is achieved.

Further, the cooking vessel 30 includes a steam inlet 34. In this example, the steam inlet 34 is arranged in the upper part 46 of the cooking vessel 30. The steam inlet 34 is connected or connectable to the steam outlet 36 of the cooking oven 10. Steam 42 is inserted into the cooking vessel 30 by the steam inlet 34.

Since the volume of the cooking vessel 30 is clearly smaller than the volume of the oven cavity 12, a saturated steam environment is obtained inside the cooking vessel 30 by less effort. Since the vessel sensor 32 is connected or connectable to the control unit 26 of the cooking oven 10, the humidity and/or temperature in the cooking vessel 30 is controllable.

FIG. 2 illustrates a schematic sectional side view of the cooking oven 10 with a cooking vessel 30 according to a second embodiment of the present invention. The cooking oven 10 includes the oven cavity 12 and the oven door 14 provided for closing said oven cavity 12. Further, the cooking oven 10 comprises the bottom heating element 16, the rear heating element 18 and the fan 20, wherein the bottom heating element 16 and the rear heating element 18 are electric heating elements. The fan 20 encloses the rear heating element 18.

Moreover, the cooking oven 10 comprises the cavity sensor 24 arranged inside the oven cavity 12. Said cavity sensor 24 may be a temperature sensor and/or a humidity sensor. The cooking oven 10 includes the control unit 26 electrically connected to the cavity sensor 24, the fan 20 and the heating elements 16 and 18. The control unit 26 is either an integrated part of the cooking oven 10 or an external device arranged out of the cooking oven 10.

Unlike the first embodiment, the cooking oven 10 according to the second embodiment does not comprise any steam generator.

Thus, the cooking oven 10 of the second embodiment as such is designed without steam cooking function.

The cooking vessel 30 according to the second embodiment is arranged inside the oven cavity 12 of the cooking oven 10. In this example, the cooking oven 10 comprises a grid 38 or tray 38 insertable or inserted inside the oven cavity 12, wherein the cooking vessel 30 is placed upon said grid 38 or tray 38. The food stuff 40 is arranged inside the cooking vessel 30. Also in this example, the cooking vessel 30 includes the lower part 44 and the upper part 46. The cooking vessel 30 is confined, but not hermetically sealed. An overpressure inside the cooking vessel 30 is not required. The cooking vessel 30 is designed that different temperature and humidity may occur inside said cooking vessel 30 on the one hand and in the residual oven cavity 12 on the other hand.

The cooking vessel 30 includes the vessel sensor 32 provided as temperature sensor and/or humidity sensor. In this example, the vessel sensor 32 is arranged in the upper part 46 of the cooking vessel 30. The vessel sensor 32 is connected or connectable to the control unit 26 of the cooking oven 10. The vessel sensor 32 inside the cooking vessel 30 allows the homogeneous temperature control regardless of the characteristics of the cooking vessel 30 and of the food stuff 40 to be treated, so that the closed loop control is achieved.

Further, the cooking vessel 30 according to the second embodiment includes a water basin 48 arranged at the bottom of the cooking vessel 30. The water basin 48 is filled by water. When the oven cavity 12 is heated at a temperature more than 100° C., then the water in the water basin 48 is evaporated. The emerging steam is used for steam cooking of the food stuff 40 in the cooking vessel 30.

The cooking vessel 30 according to the second embodiment allows steam cooking function in a conventional cooking oven 10, which is rather not provided for steam cooking function.

FIG. 3 illustrates a schematic sectional side view of the cooking oven 10 with a cooking vessel 30 according to a third embodiment of the present invention. The cooking oven 10 includes the oven cavity 12 and the oven door 14 for closing said oven cavity 12. Further, the cooking oven 10 comprises the electric bottom heating element 16, the electric rear heating element 18 and the fan 20, wherein the fan 20 encloses the rear heating element 18.

The cooking oven 10 comprises the cavity sensor 24 arranged inside the oven cavity 12, wherein said cavity sensor 24 may be a temperature sensor and/or a humidity sensor. The cooking oven 10 includes the control unit 26 electrically connected to the cavity sensor 24, the fan 20 and the heating elements 16 and 18. The control unit 26 may be designed as either an integrated part of the cooking oven 10 or an external device arranged out of the cooking oven 10.

The cooking oven 10 according to the third embodiment does not comprise any steam generator, so that the cooking oven 10 as such is designed without steam cooking function.

The cooking vessel 30 according to the third embodiment is arranged inside the oven cavity 12 of the cooking oven 10. Also in this example, the cooking oven 10 comprises a grid 38 or tray 38 insertable or inserted inside the oven cavity 12, wherein the cooking vessel 30 is placed upon said grid 38 or tray 38. The food stuff 40 is arranged inside the cooking vessel 30. The cooking vessel 30 includes the lower part 44 and the upper part 46. The cooking vessel 30 is confined, but not hermetically sealed. An overpressure inside the cooking vessel 30 is not required. The cooking vessel 30 is designed that different temperature and humidity may occur inside said cooking vessel 30 on the one hand and in the residual oven cavity 12 on the other hand.

Furthermore, the cooking vessel 30 includes the vessel sensor 32 provided as temperature sensor and/or humidity sensor. In this example, the vessel sensor 32 is arranged in the upper part 46 of the cooking vessel 30. The vessel sensor 32 is connected or connectable to the control unit 26 of the cooking oven 10. Also in this embodiment, the vessel sensor 32 inside the cooking vessel 30 allows the homogeneous temperature control regardless of the characteristics of the cooking vessel 30 and of the food stuff 40 to be treated, so that the closed loop control is achieved.

When the oven cavity 12 is heated that the surface of the food stuff 40 reaches a temperature more than 100° C., then the moisture in the outer portions of the food stuff 40 is evaporated. Then, the emerging steam is used for steam cooking of the food stuff 40 in the cooking vessel 30.

Also the cooking vessel 30 according to the third embodiment allows steam cooking function in a conventional cooking oven 10, which is rather not provided for steam cooking function.

The cooking vessel 30 according to the present invention may be made of different materials. For example, the cooking vessel 30 is made of Pyrex glass, aluminium, stainless steel and/or ceramic pottery. The wall thickness of the cooking vessel 30 ranges between 1 mm and 10 mm depending on the material of said cooking vessel 30. For example, if the cooking vessel 30 is made of metal, e.g. aluminium or stainless steel, then the wall thickness is about 1 mm. Contrariwise, if the cooking vessel 30 is made of ceramic pottery, then the wall thickness is about 10 mm.

The thermal conductivity of the wall of the cooking vessel 30 depends on the material and the wall thickness. For example, the specific thermal conductivity of aluminium is about 290 W/(m·K), while the specific thermal conductivity of ceramic pottery is about 0.5 W/(m·K).

For example, the base area of the cooking vessel 30 may be circular, elliptic, square or rectangular. Further, the shape of the cooking vessel 30 may be tapered bottom up or buckled. Moreover, the cooking vessel 30 may include handles in order to allow an easy handling in hot conditions.

The maximum overpressure inside the cooking vessel 30 is about 500 Pa in the case of an atmospheric steam generation system. In the case of a pressured steam generation system, the maximum overpressure inside the cooking vessel 30 is between 0.8 bar and 1.0 bar.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 cooking oven

12 oven cavity

14 oven door

16 bottom heating element

18 rear heating element

20 fan

22 steam generator

24 cavity sensor

26 control unit

30 cooking vessel

32 vessel sensor

34 steam inlet

36 steam outlet

38 grid, tray

40 food stuff

42 steam

44 lower part

46 upper part

48 water basin

1. A cooking vessel arrangeable or arranged inside an oven cavity of a cooking oven, wherein
the cooking vessel is provided for receiving food stuff being prepared by a steam cooking process,
the cooking vessel is confined or confinable, so that a higher humidity inside said cooking vessel than outside said cooking vessel is allowed,
the cooking vessel is confined or confinable in such a way that an overpressure inside said cooking vessel is limited,
the cooking vessel comprises at least one vessel sensor arranged inside said cooking vessel and connectable or connected to a control unit of the cooking oven, and
the vessel sensor includes at least one humidity sensor and/or temperature sensor.

2. The cooking vessel according to claim 1, wherein the cooking vessel includes a lower part and an upper part forming the confined or confinable cooking vessel.

3. The cooking vessel according to claim 2, wherein at least one sealing is arranged between the lower part and the upper part of the cooking vessel, wherein said sealing allows the higher humidity inside said cooking vessel than outside said cooking vessel.

4. The cooking vessel according to claim 3, wherein the at least one sealing is made of one or more food grade silicone materials.

5. The cooking vessel according to claim 1, wherein the cooking vessel includes a steam inlet connectable or connected to a steam generator of the cooking oven

6. The cooking vessel according to claim 5, wherein the cooking vessel includes a water basin arranged at a bottom of said cooking vessel, wherein the food stuff is arranged or arrangeable above said water basin.

7. A cooking oven comprising the cooking vessel (30) according to claim 1.

8. The cooking oven according to claim 7, wherein the cooking oven comprises at least one control unit for controlling at least one heating element and/or a steam generator of said cooking oven, wherein the vessel sensor is connected or connectable to said control unit.

9. The cooking oven according to claim 7, wherein the control unit is connected or connectable to at least one cavity sensor of the cooking oven.

10. The cooking oven according to claim 7, wherein the cooking oven comprises at least one steam generator and at least one steam outlet, wherein said steam outlet is arranged inside the oven cavity and connected or connectable to the cooking vessel.

11. A method for performing a steam cooking process in an oven cavity of a cooking oven, wherein
food stuff being prepared by the steam cooking process is arranged inside a confined cooking vessel,
the cooking vessel allows a higher humidity inside said cooking vessel than outside said cooking vessel within said oven cavity,
an overpressure inside said cooking vessel is limited,
the cooking vessel is arranged inside the oven cavity,
the humidity and/or the temperature inside the cooking vessel are detected by at least one vessel sensor arranged inside said cooking vessel, and
the detected humidity and/or temperature inside the cooking vessel are used for controlling the steam cooking process.

12. The method for according to claim 11, wherein the steam is generated by at least one steam generator of the cooking oven, wherein the cooking vessel is connected to said at least one steam generator.

13. The method for according to claim 11, wherein the steam is generated by water contained in a water basin arranged at a bottom of said cooking vessel, when the oven cavity is heated.

14. The method for according to claim 11, wherein the steam is generated by water, liquids and/or moisture contained in the food stuff when the oven cavity is heated.

15. (canceled)

16. A cooking oven comprising:
a cooking cavity and a heating element for generating cooking temperatures within said cooking cavity;
a steam generator configured to generate steam and having a steam outlet;
a control unit for controlling said heating element and said steam generator;
a cavity sensor inside said cooking cavity, said cavity sensor configured to detect at least one of temperature and humidity inside said cooking cavity;
a steam-cooking vessel received within said cooking cavity and defining a confined steam-cooking volume therein,
said steam-cooking vessel comprising an upper part and a lower part defining said steam-cooking volume, a seal between said upper part and said lower part, a vessel sensor and a steam inlet, said seal not being hermetic so that in case of overpressure within said steam-cooking vessel said overpressure can escape, said vessel sensor configured to detect at least one of temperature and humidity inside said steam-cooking vessel;
said steam outlet of said steam generator being connected with said steam inlet of said steam-cooking vessel in order to deliver steam generated in said steam generator directly into said confined steam-cooking volume, wherein as a result thereof a temperature and humidity within said steam-cooking vessel can be different than within said cooking cavity outside said steam-cooking vessel;
said control unit being operatively connected to said cavity sensor and to said vessel sensor and configured to control a cooking operation by regulating said heating element and said steam generator in response to temperature and/or humidity information from each of said cavity sensor and said vessel sensor.

17. The cooking oven according to claim 16, said seal configured to permit overpressure venting at a maximum overpressure within said steam-cooking vessel of 500 Pa.
